(19) United States
(12) Patent Application Publication
(10) Pub. No.: US 2007/0222848 A1
(43) Pub. Date: Sep. 27, 2007

(54) Method and apparatus for enhancing gray scale performance of light emitting diodes

(75) Inventor: Shih-Ting Chang, Taoyuan City (TW)

Correspondence Address: BRUCE H. TROCELL;SUITE 1404, 5205 LEESBURG PIKE, FALLS CHURCH, VA, 22041, US

(73) Assignee: Holtek Semiconductor Inc.

(21) Appl. No.: 11/385,849

(22) Filed: Mar. 22, 2006

(51) Int. Cl. B41J 2/40

(52) U.S. Cl. 347/143

(57) ABSTRACT

The present invention relates a method and apparatus for enhancing gray scale performance of a light emitting diode, that the apparatus comprises: a current source, for provide a current to the light emitting diode; an amplitude modulation (AM) register, for storing the current value and a timing value, both being defined by a user; a current setting register, for defining a current setting with respect to the user-defined current value registered in the AM register while outputting the same to the current source; a timing setting register, for setting a duration with respect to the user-defined timing value registered in the AM register while outputting the same to the current source for controlling the lasting of current being outputting from the current source.

### FIELD OF THE INVENTION

The present invention relates to a method and apparatus for enhancing gray scale performance of light emitting diode, and more particularly, to an improved technique of pulse width modulation (PWM) utilizing user-defined amplitude modulation (AM) capable of overcoming the problem of the poor starting performance of a light emitting diode as it is being used for controlling the current flowing therethrough.

### BACKGROUND OF THE INVENTION

With the imaging appliance revolution underway along with the advance of electronic industry, the need for more advanced display devices is increasing and the flat-panel mobile display industry is searching for a display technology that will revolutionize the industry. The need for new lightweight, low-power, high brightness, and extensive endurance display devices has pushed the display industry to revisit the current flat-panel digital display technology. Compared with other display technologies, the LED display has the following advantages, such as self-luminescence, super-thin appearance, high brightness, high luminance efficiency, short response time, power saving, wide temperature tolerance, flexible panel, and so forth. Therefore, the LED display is believed to be the major trend of the display market for the coming generation.

Pulse width modulation (PWM) is a powerful technique for controlling analog circuits with a microprocessor's digital outputs, which is especially popular to be used for controlling gray scale of a conventional electro-luminescence (EL). As intuitive and simple as analog control may seem, it is not always economically attractive or otherwise practical. For one thing, analog circuits tend to drift over time and can, therefore, be very difficult to tune. Precision analog circuits, which solve that problem, can be very large, heavy, and expensive. By controlling analog circuits digitally, not only the accuracy of control is improved, but also system costs and power consumption can be drastically reduced. In a nutshell, PWM is a way of digitally encoding analog signal levels. Through the use of high-resolution counters, the duty cycle of a square wave is modulated to encode a specific analog signal level. The PWM signal is still digital because, at any given instant of time, the full current supply is either fully on or fully off. The current source is supplied to the analog load by means of a repeating series of on and off pulses. The on-time is the time during which the current supply is applied to the load, and the off-time is the period during which that supply is switched off. Please refer to FIG. 1, which shows an idea current output of a conventional PWM method for controlling a light emitting diode as the horizontal coordinate represents time and the vertical coordinate represents current value. Most conventional PWM methods are linear control methods, which outputs at a 1/(N−1) duty cycle while the brightness of a light emitting diode is set to be 1 out of N gray scale, that is, the signal is on for the first step 10 of the period and off the other steps as the maximum on-time is divided into N steps. However, in reality, the electric characteristic of the light emitting diode is not as perfect as that shown in FIG. 1. Please refer to FIG. 2, which shows an actual current output of a conventional PWM method for controlling a light emitting diode. As seen in FIG. 2, there is a rising time existed at the start of charging an EL by a constant current source for raising the charging current from zero to the defined constant value, that causes the area of the first step 21 defined by the profile 22 including the rising time to be different from that of the second step 23. Thus, as the consequence, the current flux at a 2/(N−1) duty cycle is not twice the 1/(N−1) duty cycle while the brightness of the EL is set to be 2 out of N gray scale, and the linearity of the setting of gray scale is lost. Moreover, since the rising time existed in the first step 21 is dependent to the capacitor resistance and the resistance of the EL to be charged thereby, different ELs may display different brightness, i.e. different gray scales, that it is difficult to control the performance of a display using the same.

Please refer to FIG. 3, which is a diagram illustrating a profile of current output of a pre-charge method for a light emitting diode. To improve the aforesaid shortcoming, a pre-charge method is provided, which precharges the EL by a higher voltage so as to shorten the rising time as the curve 33 shown in FIG. 3. By the pre-charge method, the area of the first step 31 is approaching that of the second step 32. However, if the EL is pre-charged by a voltage that is too high, the EL might be lit up earlier than expected that while the brightness of the EL is set to be 1 out of N gray scale, the EL is on through the third step 34 and the first step 31 while is off through out the other steps such that the brightness of grade scale 1 defined by the curve 33 is too high.

Therefore, it is in great need to have a driving method for enabling a light emitting diode to have optimal gray scale performance while capable of overcoming the abovementioned shortcomings.

### SUMMARY OF THE INVENTION

In view of the disadvantages of prior art, the primary object of the present invention is to provide an improved technique of pulse width modulation (PWM) utilizing user-defined amplitude modulation (AM) capable of overcoming the problem of the poor starting performance of a light emitting diode as it is being used for controlling the current flowing therethrough.

To achieve the above object, the present invention provides an apparatus for enhancing gray scale performance of a light emitting diode, which comprises:
a current source, for provide a current to the light emitting diode;
an amplitude modulation (AM) register, for storing a current value and a timing value, both being defined by a user;
a current setting register, for defining a current setting with respect to the user-defined current value registered in the AM register while outputting the same to the current source;
a timing setting register, for setting a duration with respect to the user-defined timing value registered in the AM register while outputting the same to the current source for controlling the lasting of current being outputting from the current source.

Furthermore, the present invention provides a method for enhancing gray scale performance of a light emitting diode, which comprises steps of:
storing a current value and a timing value, both being defined by a user, in an amplitude modulation (AM) register;
defining a current setting with respect to the user-defined current value registered in the AM register while outputting the same to a current source by a current setting register;
setting a duration with respect to the user-defined timing value registered in the AM register while outputting the same by a timing setting register to the current source for controlling the lasting of current being outputting from the current source;
enabling the current source to output a current to a light emitting diode according to the current setting and the duration received respectively from the current setting register and the timing setting register; and
switching to a normal current mode defined by a normal current setting register after the operations of the AM register is completed.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 shows an idea current output of a conventional PWM method for controlling a light emitting diode.

FIG. 2 shows an actual current output of a conventional PWM method for controlling a light emitting diode.

FIG. 3 is a diagram illustrating a profile of current output of a pre-charge method for a light emitting diode.

FIG. 4 is a functional block diagram of an apparatus for enhancing gray scale performance of light emitting diodes according to the present invention.

FIG. 5A is a schematic diagram showing the initial current, being elevated by a current setting mechanism, for activating a light emitting diode according to the present invention.

FIG. 5B is a schematic diagram showing a near perfect waveform outputted by a PWM method of the present invention.

FIG. 6 is a flow chart depicting the operation of the apparatus of FIG. 4.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

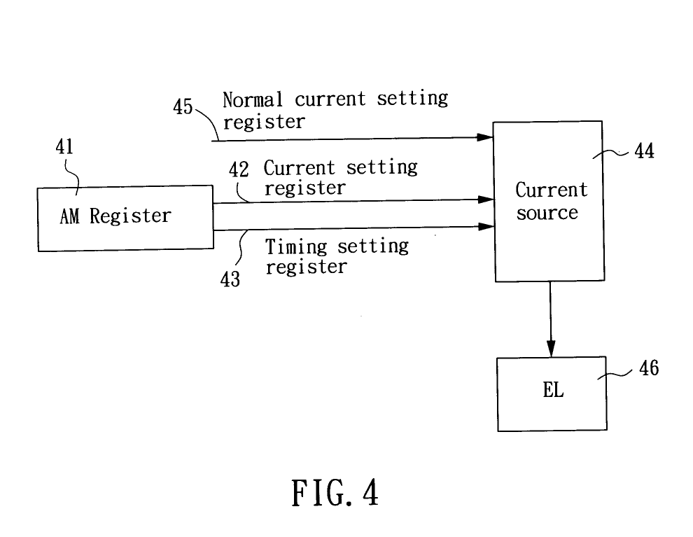

Please refer to FIG. 4, which is a functional block diagram of an apparatus for enhancing gray scale performance of light emitting diodes according to the present invention. As seen in FIG. 4, the apparatus for enhancing gray scale performance of a light emitting diode comprises:
a current source 44, for provide a current to the light emitting diode while the light emitting diode can be an electro-luminescence (EL) 46;
an amplitude modulation (AM) register 41, for storing a current value and a timing value, both being defined by a user;
a current setting register 42, for defining a current setting with respect to the user-defined current value registered in the AM register 41 while outputting the same to the current source 44;
a timing setting register 43, for setting a duration with respect to the user-defined timing value registered in the AM register 41 while outputting the same to the current source 44 for controlling the lasting of current being outputting from the current source 44; and
a normal current setting register 45, for switching to a normal current mode after the operations of the AM register 41 is completed.
wherein, the user-defined current value stored in the AM register 41 is larger than a current specified by the normal current setting register 45.

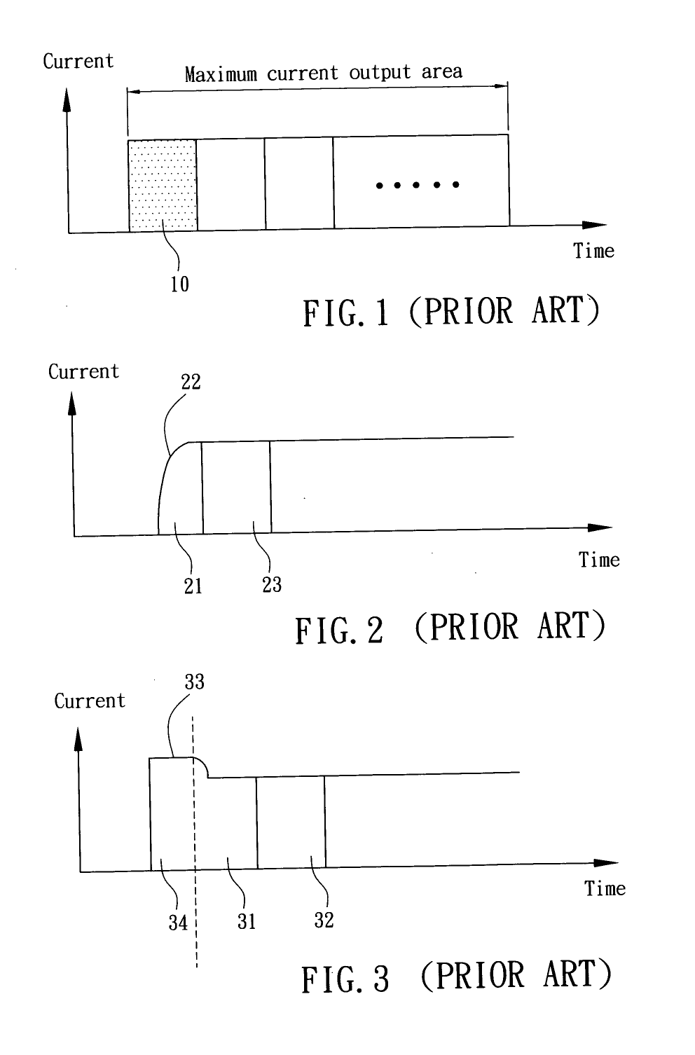

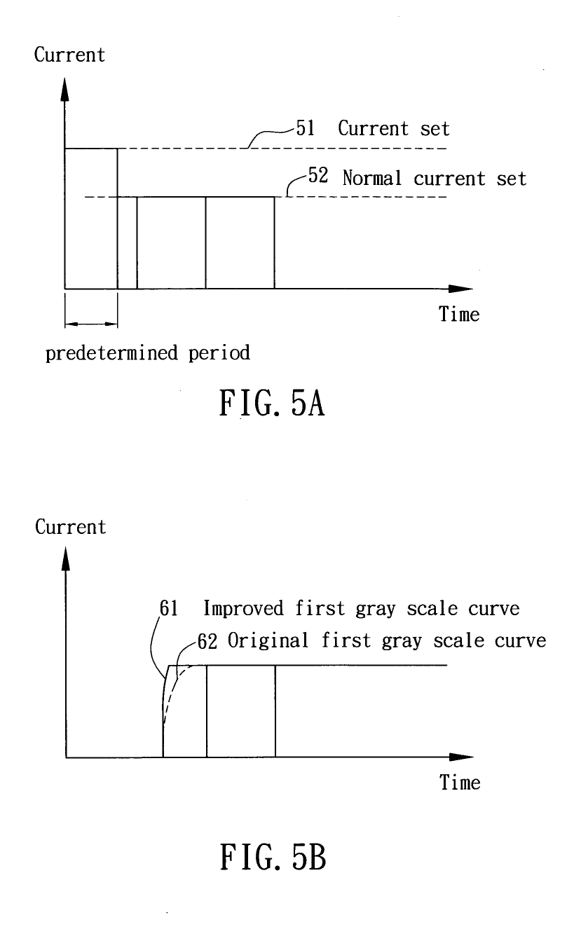

Please refer to FIG. 5A and FIG. 5B, which are schematic diagrams respectively showing the initial current, being elevated by a current setting mechanism, for activating a light emitting diode and a near perfect waveform outputted by a PWM method of the present invention. As the current source 44 is first started, a larger-than-required current, which is defined by a user, is provided thereto by the AM register 41 through a modulation mechanism comprising the current setting register 42 and the timing setting register 43 for reducing the effect of rising time, whereas the user-defined current of the AM register is the current 51 of FIG. 5A and is larger than the normal current 52 required to charge a EL. It is noted that the timing setting register 43 is used for setting a duration while outputting the same to the current source 44 for controlling the lasting of current being outputting from the current source 44, and the current outputted from the current source 44 is set to be the normal current 52 as soon as the operations of the AM register 41 is completed, which is determined by cooperation of the current setting register 42 and the timing setting register 43. Accordingly, the modulated waveform 61 outputted by a PWM method of the present invention for lighting the EL 46 is approaching the perfect waveform shown in FIG. 1 as it is compared with the non-modulated waveform 62.

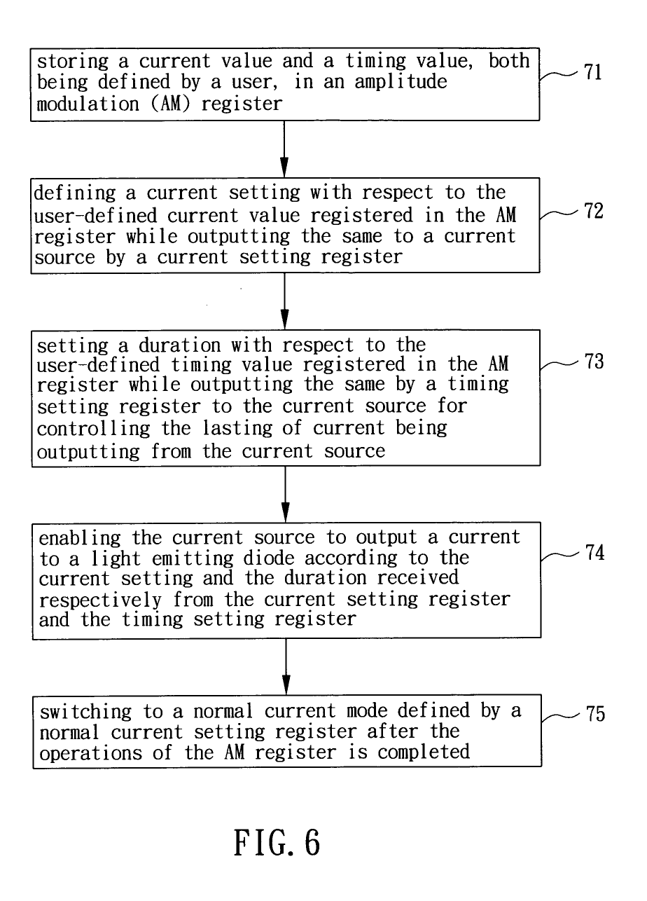

Please refer to FIG. 6, which is a flow chart depicting the operation of the apparatus of FIG. 4. The method depicting in the flow chart comprises the steps of:
(71) storing a current value and a timing value, both being defined by a user, in an amplitude modulation (AM) register;
(72) defining a current setting with respect to the user-defined current value registered in the AM register while outputting the same to a current source by a current setting register;
(73) setting a duration with respect to the user-defined timing value registered in the AM register while outputting the same by a timing setting register to the current source for controlling the lasting of current being outputting from the current source and enabling the user-defined current value stored in the AM register to be larger than a current specified by any common normal current setting register;
(74) enabling the current source to output a current to a light emitting diode according to the current setting and the duration received respectively from the current setting register and the timing setting register; and
(75) switching to a normal current mode defined by a normal current setting register after the operations of the AM register is completed.

To sum up, the present invention is related to an improved technique of pulse width modulation (PWM) utilizing user-defined amplitude modulation (AM) capable of overcoming the problem of the poor starting performance of a light emitting diode as it is being used for controlling the current flowing therethrough.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An apparatus for enhancing gray scale performance of a light emitting diode, comprising:
a current source, for provide a current to the light emitting diode;
an amplitude modulation (AM) register, for storing a current value and a timing value, both being defined by a user;
a current setting register, for defining a current setting with respect to the user-defined current value registered in the AM register while outputting the same to the current source; and
a timing setting register, for setting a duration with respect to the user-defined timing value registered in the AM register while outputting the same to the current source for controlling the lasting of current being outputting from the current source;
wherein, the user-defined current value stored in the AM register is larger than a current specified by any common normal current setting register.

2. The apparatus of claim 1, further comprises:
a normal current setting register, for switching to a normal current mode after the operations of the AM register is completed.

3. The apparatus of claim 1, wherein the light emitting diode is an electro-luminescence (EL).

4. A method for enhancing gray scale performance of a light emitting diode, comprising steps of:
(A) storing a current value and a timing value, both being defined by a user, in an amplitude modulation (AM) register;
(B) defining a current setting with respect to the user-defined current value registered in the AM register while outputting the same to a current source by a current setting register;
(C) setting a duration with respect to the user-defined timing value registered in the AM register while outputting the same by a timing setting register to the current source for controlling the lasting of current being outputting from the current source and enabling the user-defined current value stored in the AM register to be larger than a current specified by any common normal current setting register; and
(D) enabling the current source to output a current to a light emitting diode according to the current setting and the duration received respectively from the current setting register and the timing setting register.

5. The method of claim 4, further comprising a step of:
(E) switching to a normal current mode defined by a normal current setting register after the operations of the AM register is completed.
